(19) United States
(12) Patent Application Publication
(10) Pub. No.: US 2011/0304619 A1
(43) Pub. Date: Dec. 15, 2011

(54) PRIMITIVE QUADRIC SURFACE EXTRACTION FROM UNORGANIZED POINT CLOUD DATA

(75) Inventors: Yan Fu, Shanghai (CN); Jin Yang, Shanghai (CN); Xiaofeng Zhu, Shanghai (CN); Zhenggang Yuan, Beijing (CN)

(73) Assignee: AUTODESK, INC., San Rafael, CA (US)

(21) Appl. No.: 12/849,670

(22) Filed: Aug. 3, 2010

Related U.S. Application Data
(60) Provisional application No. 61/353,492, filed on Jun. 10, 2010.

(51) Int. Cl. G06T 17/00

(52) U.S. Cl. 345/420

(57) ABSTRACT

A method, apparatus, system, article of manufacture, and data structure provide the ability to extract a primitive quadric surface from point cloud data. Point cloud data is obtained in 3D space. The point cloud data is segmented to create a disjoined surface and a smooth surface segment based on spatial connectivity and surface smoothness. One or more shapes are extracted from the point cloud data using geometric fitting. The geometric fitting searches for one or more quadric surface parameters of a given type of model that provides a best agreement between selected points from the point cloud data and a resultant model.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/353,492, filed Jun. 10, 2010, by Yan Fu, Jin Yang, Xiaofeng Zhu, and Zhenggang Yuan, entitled “PIPE RECONSTRUCTION FROM UNORGANIZED POINT CLOUD DATA,” attorneys' docket number 30566.463-US-P1;

This application is related to the following co-pending and commonly-assigned patent applications, which applications are incorporated by reference herein:

U.S. patent application Ser. No. 12/849,647, entitled “PIPE RECONSTRUCTION FROM UNORGANIZED POINT CLOUD DATA”, by Yan Fu, Xiaofeng Zhu, Jin Yang, and Zhenggang Yuan, Attorney Docket No. 30566.463-US-U1, filed on Aug. 3, 2010 which application claims the benefit of Provisional Application Ser. No. 61/353,486, filed Jun. 10, 2010, by Yan Fu, Xiaofeng Zhu, Jin Yang, and Zhenggang Yuan, entitled “PIPE RECONSTRUCTION FROM UNORGANIZED POINT CLOUD DATA,” attorneys' docket number 30566.463-US-P1.

### BACKGROUND OF THE INVENTION

1. Field of the Invention

The present invention relates generally to three-dimensional (3D) modeling, and in particular, to a method, system, apparatus, and article of manufacture for extracting primitive quadric surfaces from unorganized point cloud data.

2. Description of the Related Art

(Note: This application references a number of different publications as indicated throughout the specification by the first author and year of publication enclosed in brackets, e.g., [Doe 2010]. A list of these different publications ordered according to these authors and year of publications can be found below in the section entitled “References.” Each of these publications is incorporated by reference herein.)

Primitive quadric surfaces (plane, sphere, cylinder, cone, torus) fitting are an important component of industrial constructions. Therefore, fitting a set of primitive geometric shapes to properly describe the point cloud data from real scene becomes a main principle of as-built CAD modeling. In this regard, there is increasing demand for accurate, as-built 3D models of existing sites in many application areas such as planning, revamping, heritage preservation and virtual reality. For traditional photogrammetry, it is difficult to get the complete CAD models with only point and line measurement. CAD based photogrammetry (e.g. Piper [Ermes 1999]) was developed to retrieve CAD models from photos by dropping a model selected from a CAD model library and then aligning the projected contours to the visible edges in the images based on various specified geometrical and topological constraints on the model. However, since photos do not contain explicit 3D information, automatic modeling based on photogrammetry is still difficult.

Recent advances in 3D scanning technologies have made the fast acquisition of dense and accurate point cloud data possible with moderate costs. The use of laser scanners for 3D reality capture has grown considerably in the last few years, especially for industrial reconstruction application [Laser scanner survey 2005]. Laser scanners provide high density 3D measurements, which provide enough 3D information for accurate and detailed 3D modeling. The explicit 3D information of point cloud data is also very important for automation.

Although point cloud data may be good for simple visualization, it cannot be used directly for applications like planning and clash detection. To convert point cloud data into CAD models, modeling is a necessary step because it can provide better accuracy and makes the resulting models fit well with subsequent engineering workflow. Moreover, by fitting the data set with models, the missing data in point clouds such as gaps caused by occlusion can also be recovered, noise can be averaged and the information can be compressed from millions of points to a few parameters of CAD objects.

However, the modeling process is always the bottleneck and the most time consuming process during the reconstruction of industrial sites. Most existing modeling tools for point cloud data involve heavy human intervention. How to make the 3D reconstruction from point cloud data is far from solved. Primitive quadric surface fitting is the main principle of as-built CAD modeling. The fitting problem can be divided into two parts: firstly a segmentation strategy is needed to group together the points that are spatially close and share similar local surface properties; and the second problem is how to faithfully fit surfaces of known types to segmented points. While planes and spheres can be easily fitted by a linear least square fitting approach, the fitting of cylinders, cones and tori is non-linear. How to resolve this non-linear least square quadric surface fitting problem efficiently and robustly is addressed by one or more embodiments of the invention.

Embodiments of the invention aim to improve the quality and efficiency of modeling from point cloud data, especially for the extraction of primitive quadric surfaces. For all the techniques discussed herein, it may be assumed that the input is raw unorganized 3D point cloud data. Further it is not assumed that the estimated normal of a point is accurate with regard to the extracted shape, which makes the algorithms less sensitive to noise.

Various prior art techniques have been attempted to resolve problems for fitting quadric surfaces. Although parameter decomposition approach has been used to the fitting of the quadric surfaces by [Jiang 2005], a good initial value is still very important to obtain a good result. Jiang failed to determine how to obtain a good initial value. Since cylinder, cone and torus are all revolved surface, Lukcas [Lukcas 1998] proposed to get the initial estimation of the axis of rotation of the surface by computing a straight line intersecting all the normal lines of the points on the surface. However, Lukcas' approach is not robust and cannot obtain good result especially for noisy point cloud data. Therefore, in embodiments of the present invention (as discussed in further detail below), different approaches are utilized to obtain the initial estimation of the surface based on the analysis of the features of cylinders, cones and tori.

### SUMMARY OF THE INVENTION

One or more embodiments of the invention address a fundamental problem in shape extraction from unorganized point cloud data—primitive quadric surface extraction. As a pre-computation, the approaches of computing elementary information including normals and connectivity are introduced. A region-growing based segmentation approach can be employed to group together the points that are spatially close and share similar local surface properties. The points grouped together most likely belong to the same surface. The method used for fitting a single surface with known types (planes, spheres, cylinders, cones and tori) to a set of 3D points is described. The distance used for minimization in the fitting process is faithful, which increases the fitting accuracy. By decomposing the parameters into two parts, the number of parameters considered in the optimization process is reduced, thereby the risk of dropping into a local minima and the time cost are reduced, which makes this shape fitting approach both robust and efficient.

### BRIEF DESCRIPTION OF THE DRAWINGS

Referring now to the drawings in which like reference numbers represent corresponding parts throughout:

FIG. 1 is an exemplary hardware and software environment 100 used to implement one or more embodiments of the invention;

FIG. 2 shows the normal estimation result of two point cloud data;

FIG. 3 illustrates a K-d tree for 2D point cloud data in accordance with one or more embodiments of the invention;

FIG. 4 is a flowchart illustrating the process of region-growing based segmentation in accordance with one or more embodiments of the invention;

FIG. 5 illustrates the parameterization of a cylinder in accordance with one or more embodiments of the invention;

FIG. 6 illustrates a normal of the point on a cylinder that is perpendicular to the axis of the cylinder in accordance with one or more embodiments of the invention;

FIG. 7 illustrates points on an input Gaussian sphere that forms a great circle C in a plane whose normal n equals a in accordance with one or more embodiments of the invention;

FIG. 8 illustrates the Hough Gaussian sphere where each point in the input Gaussian sphere votes for a great circle in accordance with one or more embodiments of the invention;

FIG. 9 is a snapshot of the input and Hough Gaussian sphere of a cylinder captured by a laser scanner in accordance with one or more embodiments of the invention;

FIG. 10 illustrates the parameterization of a cone in accordance with one or more embodiments of the invention;

FIG. 11 illustrates that for each point, the equation of \vec{p₁o}·\vec{n}ᵢ=\vec{co}·\vec{n}ᵢ; holds in accordance with one or more embodiments of the invention;

FIG. 12 illustrates the parameterization of a torus in accordance with one or more embodiments of the invention;

FIG. 13 illustrates the tangent vectors of latitude curves in accordance with one or more embodiments of the invention;

FIG. 14 illustrates differential properties of the points on a torus surface that can be used for resolved axis determination; and

FIG. 15 illustrates the logical flow for extracting a primitive quadric surface from point cloud data in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

As described above, the prior art approaches fail to obtain satisfactory shape extraction/fitting results based on noisy point cloud data. Therefore, in embodiments of the present invention, different approaches are utilized to obtain the initial estimation of the surface based on the analysis of the features of cylinders, cones and tori. For the cylinder fitting, quadric fitting or plane fitting of the normal mapping on the Gaussian sphere has been used to get an initial estimation of the parameters of cylinders [Tahir 2005]. However such methods and estimated results may not provide results as advantageous as those generated by a Hough transform—thus making the optimization process take longer time. For the cone fitting, the initial axis estimation approach is based on the observation that the projections of the vector from the point to the origin onto its normal vector have equal length. The initial axis position estimation is a non-linear optimization process itself that can generate better results than the prior approach proposed by Lukcas [Lukcas 1998]. For the torus fitting, the axis estimation is based on principal curvature directions that achieve better results than by finding a line intersecting all the normal lines.

### Hardware Environment

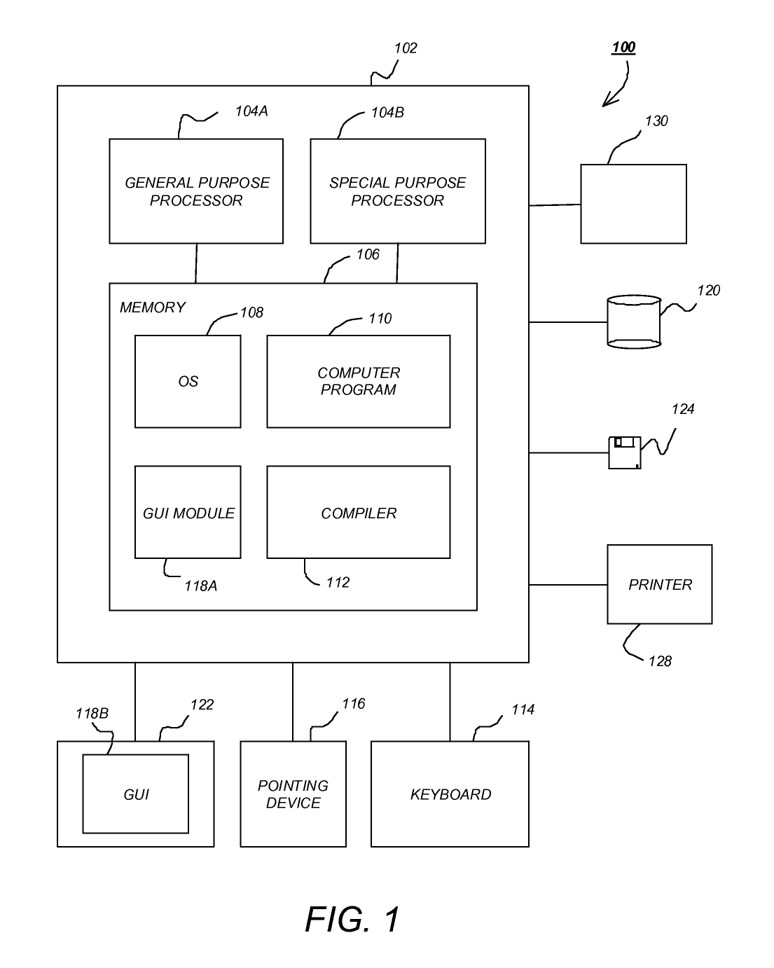

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to other devices, including input/output (I/O) devices such as a keyboard 114, a cursor control device 116 (e.g., a mouse, a pointing device, pen and tablet, etc.) and a printer 128.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108 to provide output and results.

Output/results may be presented on the display 122 or provided to another device for presentation or further processing or action. In one embodiment, the display 122 comprises a liquid crystal display (LCD) having a plurality of separately addressable liquid crystals. Each liquid crystal of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118A. Although the GUI module 118A is depicted as a separate module, the instructions performing the GUI functions can be resident or distributed in the operating system 108, the computer program 110, or implemented with special purpose memory and processors.

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 102 may also implement a compiler 112 which allows an application program 110 written in a programming language such as COBOL, Pascal, C++, FORTRAN, or other language to be translated into processor 104 readable code. After completion, the application or computer program 110 accesses and manipulates data accepted from I/O devices and stored in the memory 106 of the computer 102 using the relationships and logic that was generated using the compiler 112.

The computer 102 also optionally comprises an external communication device such as a modem, satellite link, Ethernet card, or other device for accepting input from and providing output to other computers.

In one embodiment, instructions implementing the operating system 108, the computer program 110, and the compiler 112 are tangibly embodied in a computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program instructions which, when accessed, read and executed by the computer 102, causes the computer 102 to perform the steps necessary to implement and/or use the present invention or to load the program of instructions into a memory, thus creating a special purpose data structure causing the computer to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 102.

Although the term “user computer” or “client computer” is referred to herein, it is understood that all computers 102 described herein may include portable devices such as cell phones, notebook computers, pocket computers, or any other device with suitable processing, communication, and input/output capability.

In addition, all of the actions and components described herein may be provided by such a computer 102, computer program 110, or other component of FIG. 1.

### Preliminary Processing

In this section, the approaches of computing normal and connectivity information are introduced. Both normal and connectivity information are significant essential elements for further point cloud processing and shape modeling.

Normal Estimation

Normal information associated with each point is a very important property of the underlying surface. If normal information is not provided by the acquisition process, it needs to be estimated from the point samples. In many point cloud processing problems, a normal estimation step precedes the main task.

Uniform Plane Fitting

The normal of each point in the cloud is estimated by fitting a tangent plane to the neighbors of the point. To fit a planar surface to a set of points in a least square sense, one needs to find out the parameters that can minimize the sum of orthogonal distance from the points to the surface. The plane associated with point o is characterized by a unit normal vector n n of the plane and the distance ρ ρ from the origin to the plane. The distance from any point p=(pₓ,p_{y},p_{z}) p=(pₓ,p_{y},p_{z}) to the plane is defined as n·p−ρ; thus the fitting problem can be solved by Lagrange multiplier [Tahir 2005]:

Φ=(n·p−ρ)²−λ(n·n−1)=0 (1)

By the equations given by

$$\frac{\partial Φ}{\partial ρ} = 0 ,$$

ρ can be solved by

$$ρ = - n \cdot \overline{p} , where \overline{p} = \frac{1}{k} {\sum }_{i = 0}^{k} ( {p}_{x} , {p}_{y} , {p}_{z} ) \qquad ( 2 )$$

The fitting problem can be converted into a system of equations:

$$\begin{matrix}{\sum }_{i = 0}^{k} {( {p}_{i} - \overline{p} )}^{T} ( {p}_{i} - p ) ( \begin{matrix}{n}_{x} \\ {n}_{y} \\ {n}_{z}\end{matrix} ) = λ ( \begin{matrix}\begin{matrix}{n}_{x} \\ {n}_{y}\end{matrix} \\ {n}_{z}\end{matrix} ) & ( 3 ) \\ An = λ n & ( 4 )\end{matrix}$$

This is an eigen-vector problem and the normal of the point is given by the eigenvector of A corresponding to the minimum eigen-value. The minimum eigen-value indicates the residual of the plane fitting. The residual value approximates the curvature.

Weighted Plane Fitting

Pauly and Mitra et al. [Pauly 2003, Mitra 2004] proposed that the fitting plane for a point p should weight the nearby points more than the distant points, hence the neighboring points are assigned with different weights according to their distance from p. The weighting function is taken as a Gaussian function:

$$θ ( ‖ {p}_{i} - p ‖ ) = {e}^{- \frac{{‖ {p}_{i} - p ‖}^{2}}{{h}^{2}}} , \\ where {h}^{2} = \frac{1}{3} {min}_{i \leq k} ‖ {p}_{i} - p ‖ . \qquad ( 5 )$$

And the distance error function is defined as:

e(n,ρ)=Σᵢ₌₁^{k}(n^{T}pᵢ−ρ)θ(∥pᵢ−p∥) (6)

This distance error minimization problem can also be converted into a system of equations; hence it can also be solved by eigen-vector solution.

Normal Consistence Adjustment

The direction of the normals estimated by the above approaches is ambiguous. In some applications such as mesh reconstruction [Kazhdan 2006], consistent normals are required [Soren 2009]. The approach proposed by [Hoppe 1992] is utilized to consistently orient all the normals of the point cloud data. The problem is modeled as a Riemannian Graph optimization problem. The Riemannian graph is constructed to encode the geometric proximity of the tangent plane centers. The cost on an edge e=(i,j) encodes the degree to which Tₚ₍ₓ_{ᵢ}₎ and Tₚ₍ₓ_{ⱼ}₎ are consistently oriented, and the edge cost is defined to be w(e)=\hat{n}ᵢ·\hat{n}ⱼ. The problem is to make a binary choice bᵢε{−1,1} for each vertex i, selecting tangent plane orientation bᵢ\hat{n}ᵢ to maximize the cost function:

$${\sum }_{( i , j ) ∈ E} {b}_{i} {b}_{j} w ( i , j )$$

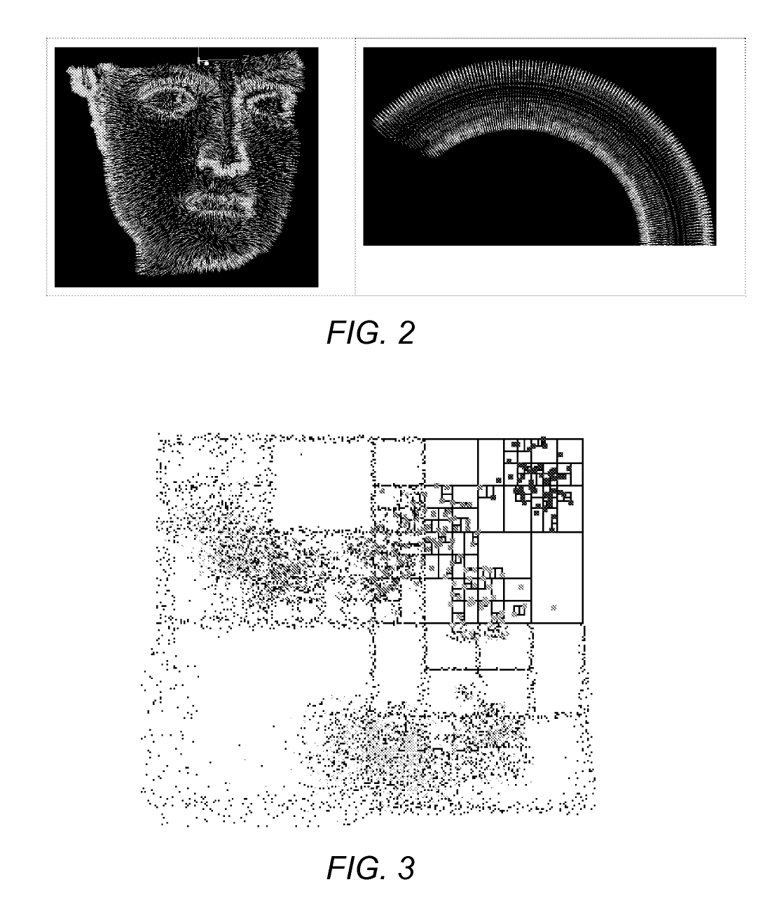

This problem is solved by an efficient and greedy approximate algorithm: First, arbitrary choose an orientation for some plane and then propagate the orientation to neighboring planes in the graphs. The propagation order is achieved by traversing the minimal spanning tree of the graph, which tends to propagate orientation along directions of low curvature in the data. FIG. 2 shows the normal estimation result of two point cloud data.

K-Nearest Neighbors (KNN)

The KNN problem is described as the following problem [Arya 1998]: Given a set S of n point data in a metric space X, we need to preprocess the data so that: given any query point qεX, compute the k-nearest neighbors to q quickly.

Algorithms in point cloud processing always makes heavy use of the neighborhood of points, which makes the nearest neighbor searching an important problem in many applications and calls for efficient approaches of computing the k-nearest neighbors of a large point cloud set. When the value of k is fixed, it can adapt the area of interest according to the point density, i.e. a bigger area will be used in the areas of lower point density while a smaller area will be used in areas of higher point density.

To efficient query the KNN for any point, a good data structure for organizing the whole point cloud data is very important. K-d tree is a good strategy to partition the space so that the KNN query will be optimized. In embodiments of the present invention, the ANN toolkit [ANN 2010] can be used for the K-nearest neighbors query. The ANN toolkit supports data structures and algorithms for both exact and approximate nearest neighbor searching in arbitrarily high dimensions. FIG. 3 illustrates a K-d tree for 2D point cloud data in accordance with one or more embodiments of the invention.

Quadric Surfaces Extraction from Point Cloud Data

As reported in [Nourse et al. 1980, Petitjean 2002], 95% of the objects found in most industrial constructions can be approximated by planes, spheres, cylinders, cones and tori. Therefore, fitting a set of primitive geometric shapes to properly describe the point cloud data from real scene becomes the main principle of as-built CAD modeling.

To extract quadric surfaces, there are two primary steps: (1) segmentation; and (2) model fitting.

Segmentation

Segmentation is an important step that can be carried out before model fitting. The problem of segmentation shares some similar ideas with clustering in pattern recognition that tries to partition a given dataset into disjoint group based on a feature space so that a specified criterion is optimized. Segmentation partitions the point cloud data into disjoined and smoothly connected regions based on the combined criterion of spatial connectivity and surface smoothness. Ideally, each surface should only result in one segment.

The segmentation used in embodiments of the present invention is a surface-based and bottom-up segmentation. It starts from some seed points and grows the segment based on some similarity criterion to group together the points that are spatially close and share similar local surface properties. This method is less sensitive to noise existing in the point cloud data.

Principal curvature is not suggested to be used as a smoothness measurement to handle curved objects [Trucco 1995], because the curvature estimation error introduced by noise will trend to result in over-segmentation. Moreover, surfaces such as torus cannot be identified based on the signs of principal curvatures. Instead, normals are more ideally used as a similarity criterion as they can be more reliable by averaging out the effect of noise by using a big enough neighborhood.

To make a smooth surface segment, the normals of the points in one segment should not vary too much from each other. This constraint is enforced by an angle threshold on the angles θₜₕ between the normal of the current seed point and the normal of points to be added into the segment. Another threshold on the residual value rₜₕ is set to prevent the surface segment from growing across sharp edges.

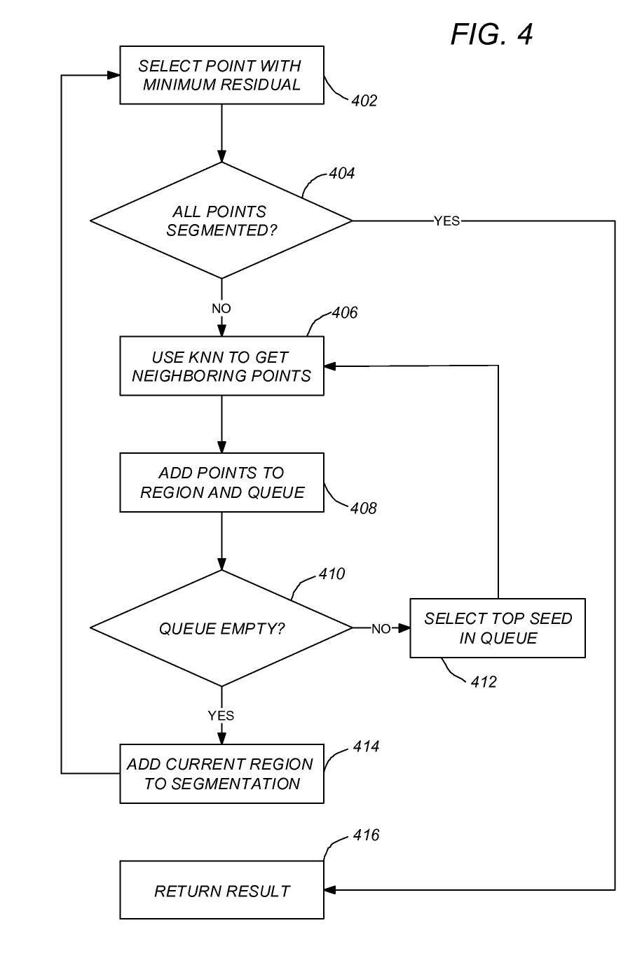

FIG. 4 is a flowchart illustrating the process of region-growing based segmentation in accordance with one or more embodiments of the invention.

At step 402, the point with minimum residual is selected as the current seed.

At step 404 a determination is made regarding whether all of the points have been segmented. If they have all been segmented, the process is finished and the segmentation result is returned at step 414.

If not all points have been segmented, KNN is used to get the neighboring points of the seed at step 406.

At step 408, the points that satisfy the condition of ∥nₚ·nₛ∥>cos(θₜₕ) are added to the current region and the points with residuals less than rₜₕ are added to the list of potential seed points queue.

A determination is made at step 410 regarding whether the potential seed queue is empty.

If the potential seed queue is not empty, the top seed in the queue is selected as the next seed at step 412 and the process continues with step 406.

If the potential seed queue is empty, the current region is added to the segmentation at step 414 and the process returns to step 402.

Faithful Fitting to Quadric Surfaces/Model Fitting

After segmentation, surface fitting of planes, spheres, cylinders, cones and tori from point cloud data in 3D space is performed. Geometric fitting is a fundamental task in shape extraction from point cloud data. It can be posed as an optimization problem, where one searches for those parameters of a given type of model that lead to the best agreement between the selected points and the resultant model. A distance measurement is employed for the fitting purpose. Algebraic and orthogonal (or geometric) distances are two typical distance measures used for surface fitting.

Algebraic distance can be used for surfaces that can be expressed into an implicit function, e.g. plane and sphere. In this way surface fitting can be converted into a linear least square problem and can be solved by linear equation solvers. Linear least square fitting for planes and sphere are efficient and robust. In contrast, cylinders, cones and tori can only be fit using non-linear least square fitting.

Typically, the Levenberg-Marquardt method is used to solve the optimum of highly complex optimization problems. Usually, a good initial estimation of the optimum is required for such kind of iterative optimization method and the final result depends highly on the quality of these estimates. Moreover, a large parameter space will result in risks of getting in local minimum, thus making the algorithm unstable and inefficient. [Lukács 1998, Marshall et al., 2001] treat all of the parameters for optimization simultaneously. To resolve this problem, embodiments of the invention apply a parameter decomposition technique for quadric surface fitting proposed in [Jiang 2005] to reduce the dimension of parameter spaces, i.e. the quadric surface parameters are decomposed into two parts, one part can be solved by iterative optimization process and the other part can be solved directly.

Plane Fitting

A plane is parameterized by four parameters v=(a, b, c, d). The equation of the plane can be written as ax+by+cz+d=0. Thereafter, the plane fitting problem can be converted into a problem of solving an over-determined equation:

$$Ax = 0 , A = [ \begin{matrix}{x}_{1} & {y}_{1} & {z}_{1} & 1 \\ {x}_{2} & {y}_{2} & {z}_{2} & 1 \\ ⋮ & ⋮ & ⋮ & ⋮ \\ {x}_{n} & {y}_{n} & {z}_{n} & 1\end{matrix} ] , x = {( a , b , c , d )}^{T} \qquad ( 7 )$$

This problem is an eigen-value problem, with the minimum solution given by the eigen-vector of (A^{T}A) corresponding to its minimum eigen-value.

Sphere Fitting

A sphere is parameterized by the center c=(cₓ, c_{y}, c_{z}) and its radius r.

Consider the distance function:

$$\begin{matrix}F ( {c}_{x} , {c}_{y} , {c}_{z} , r ) = {\sum }_{i = 1}^{n} [ {( {x}_{i} - {c}_{x} )}^{2} + {( {y}_{i} - {c}_{y} )}^{2} + {( {z}_{i} - {c}_{z} )}^{2} - {r}^{2} ] \\ = {\sum }_{i = 1}^{n} [ - ( 2 {c}_{x} {x}_{i} + 2 {c}_{y} {y}_{i} + 2 {c}_{z} {z}_{i} ) + ρ + ( {c}_{x}^{2} + {c}_{y}^{2} + {c}_{z}^{2} ) ]\end{matrix}$$

Where ρ=(cₓ²+c_{y}²+c_{z}²)−r². Variable ρ is introduced to make the equation linear, thus an analytic solution exists for sphere fitting.

$$Ax = b , where A = [ \begin{matrix}{x}_{1} & {y}_{1} & {z}_{1} & 1 \\ {x}_{2} & {y}_{2} & {z}_{2} & 1 \\ ⋮ & ⋮ & ⋮ & ⋮ \\ {x}_{n} & {y}_{n} & {z}_{n} & 1\end{matrix} ] , x = {( a , b , c , d )}^{T} , \\ b = - [ \begin{matrix}{x}_{1}^{2} + {y}_{1}^{2} + {z}_{1}^{2} \\ {x}_{2}^{2} + {y}_{2}^{2} + {z}_{2}^{2} \\ ⋮ \\ {x}_{n}^{2} + {y}_{n}^{2} + {z}_{n}^{2}\end{matrix} ] \qquad ( 8 )$$

This is an over-determined equation; the value of x can be determined by singular value decomposition (SVD). Thereafter, the parameters of the sphere can be computed by:

$$\{ \begin{matrix}{c}_{x} = - \frac{a}{2} \\ {c}_{y} = - \frac{b}{2} \\ {c}_{z} = - \frac{c}{2} \\ r = \frac{\sqrt{{a}^{2} + {b}^{2} + {c}^{2} - 4 d}}{2}\end{matrix} \qquad ( 9 )$$

Cylinder Fitting

Cylinders are one of the most frequently used primitives for industrial design, especially for processing industries like nuclear plants, petrochemical plant. Therefore, the detection and fitting of cylinders are very essential for the reconstruction of industrial sites.

The equation for a cylinder is:

$$\begin{matrix}F ( x , y , z ) = \sqrt{\begin{matrix}{[ ( x - {x}_{0} ) m - ( y - {y}_{0} ) l ]}^{2} + {[ ( y - {y}_{0} ) n - ( z - {z}_{0} ) m ]}^{2} + \\ {[ ( z - {z}_{0} ) l - ( x - {x}_{0} ) n ]}^{2} - R\end{matrix}} \\ = 0\end{matrix} \qquad ( 10 )$$

Where o=(x₀,y₀,z₀) is a point on the axis of the cylinder, a=(m,n,l) is the unit normal vector the cylinder axis and R is the radius of the cylinder. To reduce the parameters of cylinder, the cylinder can be re-parameterized.

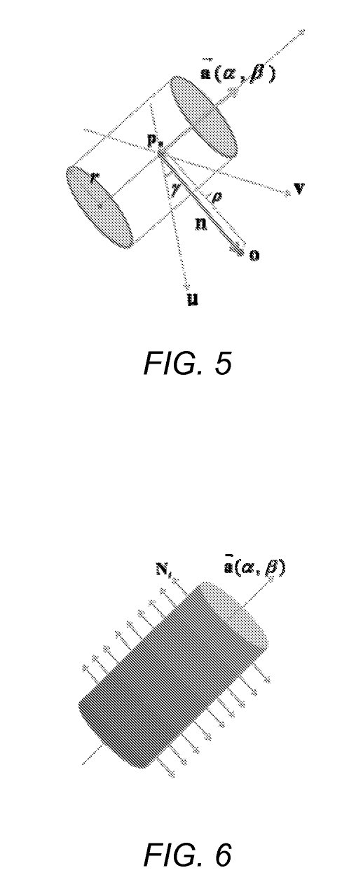

FIG. 5 illustrates the parameterization of a cylinder in accordance with one or more embodiments of the invention. Let a=a(α,β) be the unit direction vector of a 3D cylinder, where α is the angle between the projection of the vector onto the xy-plane and the x-axis, β is the angle between n and the z-axis; Then a can be parameterized by:

a=(cos α sin β,sin α sin β,−cos β) (11)

Once the direction vector of the cylinder is determined, two orthogonal vectors orthogonal to a can be defined as:

u=(−sin α,cos α,0) (12)

v=(cos α cos β,sin α cos β,−sin β) (13)

Using this orthogonal coordinate system (u,v,a) for projection, the points on the cylinder can be projected orthogonally to a plane perpendicular to a and passing through the origin. The projected points will form a 2D circle with the same radius as cylinder. Therefore, the 3D cylinder can be parameterized by five parameters:

\vec{v}=(α,β,ρ,γ,r), (14)

where ρ is the orthogonal distance from the origin to the axis of cylinder, γ is the angle between u and the unit normal vector (n=u sin γ+v cos γ) from the origin to the cylinder axis and r is the radius of the cylinder.

By the decomposition technique, the distance computation in 3D [Lukács 1998] can be reduced to the distance computation in 2D [Jiao 2005].

$$\begin{matrix}{v}_{opt} = {argmin}_{α , β} [ {min}_{ρ , γ , r} {\sum }_{i = 1}^{n} d ( {p}_{i} , f ( α , β , ρ , γ , r ) ) ] \\ = {argmin}_{α , β} {A}_{1} ( α , β )\end{matrix} \qquad ( 15 )$$

A₁(α,β) is the sum of distances between projected points and the fitted 2D circle. Thus, with the decomposition approach, the 3D cylinder fitting problem can be simplified into a 2D circle fitting problem. One only needs to optimize the value of (α,β) during the iterative optimization process. And the task for each optimization iteration is to find the best circle for the projected points based on a given (α,β).

Embodiments of the invention employ a two-step approach to get the initial parameters of a cylindrical surface. The cylinder direction is estimated in the first step and the radius and position of the cylinder are estimated in the second step. This two-step approach is robust with respect to both the noise on the point cloud data and the normal estimation, thus making it applicable to detect pipes in large digitized industrial sites with unorganized and non-uniform 3D points.

### Initial Estimation of Axis Direction

There is an important feature for the normal of points on a cylindrical surface: the estimated normals are right or approximately perpendicular to the axis of the cylinder:

N·a≅0 (16)

FIG. 6 illustrates a normal of the point on a cylinder that is perpendicular to the axis of the cylinder in accordance with one or more embodiments of the invention.

An intuitive way to estimating the axis direction is by linear least square fitting:

$$A \cdot a = 0 , A = [ \begin{matrix}{x}_{1} & {y}_{1} & {z}_{1} \\ {x}_{2} & {y}_{2} & {z}_{2} \\ ⋮ & ⋮ & ⋮ \\ {x}_{n} & {y}_{n} & {z}_{n}\end{matrix} ] \qquad ( 17 )$$

The axis direction is estimated as the eigenvector corresponding to the minimum eigen-values of the matrix. However, this approach is sensitive to noise.

Hough based methods have been used for handling problems with outliers for long [Hough 1962]. The major drawback of using a Hough transform is the time and space complexity. The time and space complexity of fitting 3D geometric shapes from point cloud data are O(s^{p-1}n) and O(s^{p}) respectively, where n is the number of points, p is the number of parameters and s is the number of samples along one Hough dimension, which makes Hough Transform impractical for estimation of objects with more than 3 parameters. Keep in mind that the fitting of the cylinder has been split into two steps and the number of parameters of axis direction is only two.

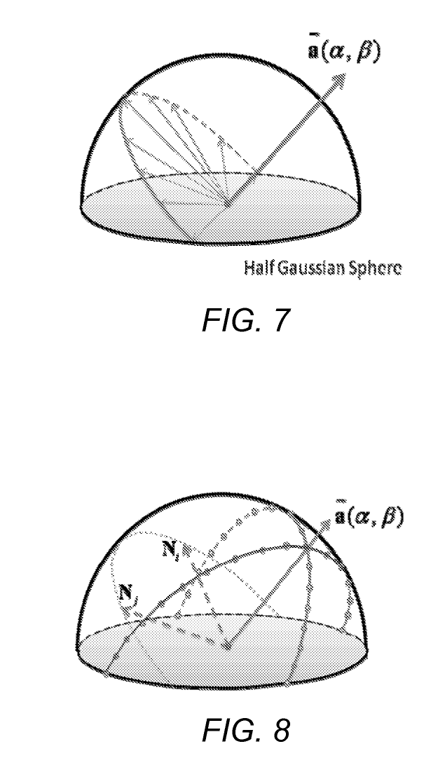

For cylinders, the normals will form a great circle on the input Gaussian sphere. The normal of the plane of the great circle can approximate the cylinder axis direction. FIG. 7 illustrates points on an input Gaussian sphere that forms a great circle C in a plane whose normal n equals a in accordance with one or more embodiments of the invention.

Although plane fitting can be employed to estimate the normal of the great circle plane, the Hough transform is used to avoid the problems caused by outliers. To find a plane by Hough transformations requires a 3D Hough space—two of the dimensions specify the direction of the plane normal expressed in spherical coordinates and the other dimension specifies the location of the plane by the distance of the plane to the origin. In this case, the plane of great circle passes through the origin. Accordingly, one can remove the third parameter and make a 2D Hough transform of the Gaussian mapping of the normals of the input points to get a hypothesis of the cylinder axis.

The Hough space for cylinder axis estimation only consists of two parameters—the direction of the plane normal, and the intersection point of the great circles. The direction of the plane normal can be also interpreted as a Hough Gaussian sphere. Each point on the input Gaussian sphere votes on the Hough Gaussian sphere for all directions whose orientation is perpendicular to the normal of the point, which is shown in FIG. 8. In this regard, FIG. 8 illustrates the Hough Gaussian sphere where each point in the input Gaussian sphere votes for a great circle in accordance with one or more embodiments of the invention. The intersection of the great circles estimates the orientation by providing a big value in the Hough space.

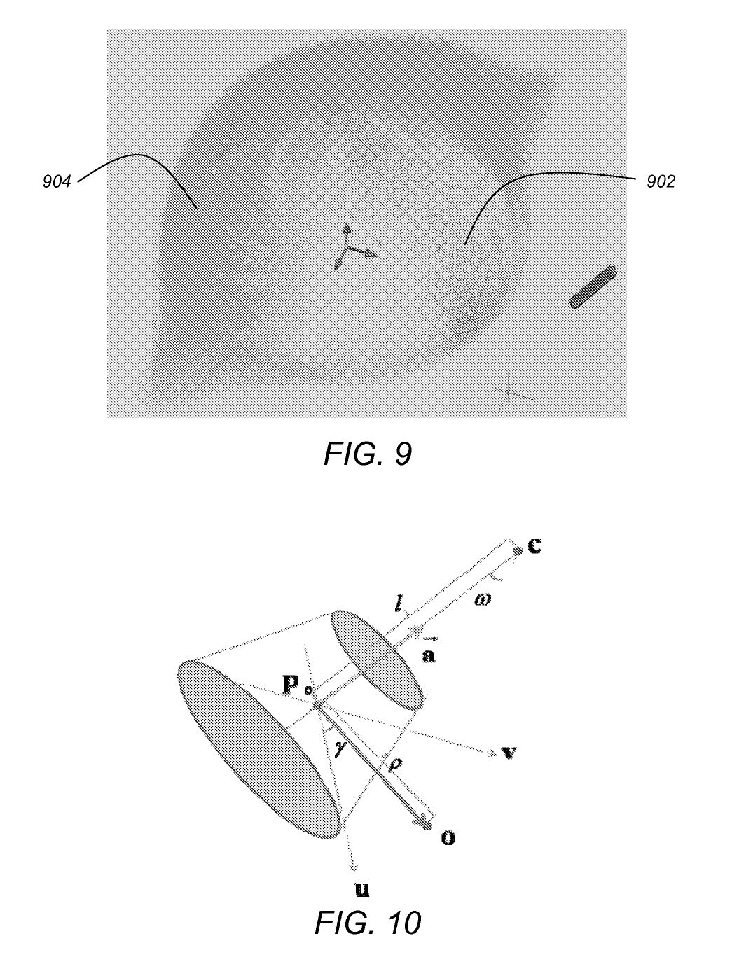

Consequently, the votes of each point on the input Gaussian sphere form another great circle on the Hough Gaussian sphere. There is a high value on the Hough space for the intersection of the great circles. And the intersection point gives the initial estimation of the axis direction of the cylinder. To determine the location of the intersection point, the Hough Gaussian sphere is discrete into a sampled Hough cell space by an approximate uniform sampling method of a sphere [Rusin 2004]. For each point in the input data, the cells with regard to the great circle are incremented in the Hough space. FIG. 9 is a snapshot of the input and Hough Gaussian sphere of a cylinder captured by a laser scanner in accordance with one or more embodiments of the invention. The points 902 are the mapping of the normals on the input Gaussian sphere while the line segments 904 on the Hough Gaussian sphere demonstrate the votes on this direction. The cell with the highest accumulation votes is the hypothesis of the cylinder direction.

### Estimation of Position and Radius

After the hypothesis of the cylinder direction is obtained, all the points of the cylinder are projected to a plane perpendicular to the estimated cylinder direction. The matrix used for projection is M=[u, v, a], where a is the cylinder axis. The position and radius of the cylinder can then be calculated by circle fitting. In this work, Taubin circle fitting [Taubin 1991] may be employed to make a robust and accurate circle fitting. This method works well even when the data are observed only within a small arc.

### Overview of Cylinder Fitting

In view of the above description, five parameters may be utilized to describe a cylinder—two describe the direction of the cylinder's axis, two parameters describe the location of the axis (e.g., the projection from the origin point to the axis), and one parameter is used to describe the radius.

The parameters are determined using a two-step approach by first estimating initial values followed by the optimization of the parameters. The initial parameters are obtained using a Gaussian sphere and a Hough transform. During optimization, the parameters are decomposed into two parts. The first part are optimized using a non-linear optimization process while the second part (i.e., the position and radius) are optimized using circle fitting (e.g., project to a plane to form a circle and then use circle fitting to determine the position and radius).

Cone Fitting

Generally, cone can be parameterized by six parameters. a=a(α,β) represents the unit vector of a cone axis, ρ and γ are denoted in the same way as that of cylinder. The position and direction of the cone axis can be defined by four parameters (α, β, ρ, γ). pₒ may be denoted as the projected point of the origin on the cone axis. Thereafter, one can define the position of the cone apex by the distance l from the apex point c to p₀. Another parameter ω, 0<ω<π/2 is used to define the angle between the cone axis and the cone surface. Therefore, a cone is defined by (α, β, ρ, γ, l, ω) as shown in FIG. 10. In this regard, FIG. 10 illustrates the parameterization of a cone in accordance with one or more embodiments of the invention.

The faithful distance minimization problem of cone fitting can be reduced into 2D point-line distance minimization problem by parameter decomposition [Jiao 2005]:

$$\begin{matrix}{v}_{opt} = {argmin}_{α , β , ρ , γ} [ {min}_{l , w} {\sum }_{i = 1}^{n} d ( {p}_{i} , f ( α , β , ρ , γ , l , w ) ) ] \\ = {argmin}_{α , β , ρ , γ} {A}_{2} ( α , β , ρ , γ )\end{matrix} \qquad ( 18 )$$

A₂(α, β, ρ, γ) is the sum of distances between rotated points and the fitted 2D line. With the decomposition technique, only four parameters (α, β, ρ, γ) need to be considered in the optimization process. The task for each optimization iteration is to find the best line for the projected points based on a given (α, β, ρ, γ).

The Levenberg-Marquardt method is utilized to solve the minimization problem. For this method, a good initial value should be provided. A two-step approach (similar to cylinder fitting) is employed to get the initial parameters of a cone. The cone axis is estimated in the first step and the position of the apex and the angle between the axis and the cone surface are estimated in the second step.

### Initial Estimation of Axis Direction

The estimation of axis of a cone itself is also an optimization problem. Estimating the axis of rotation can be achieved by computing the best straight line intersecting normals of all the points [Matthew 1993]. pᵢ is denoted as a point on the cone surface and nᵢ is denoted as the unit normal vector of the point. Note that for each point, the equation of \vec{p₁o}·\vec{n}ᵢ=\vec{co}·\vec{n}ᵢ holds. Therefore, one can first compute an initial value of the apex point c by intersecting three planes given by (p₁, n₁), (p₂, n₂) and (p₃, n₃). This problem can be solved by a linear system. The position of the apex point can be optimized by minimizing

f(cₓ,c_{y},c_{z})=Σᵢ₌₀ⁿ((c−o)·nᵢ−(pᵢ−o)·nᵢ)², (19)

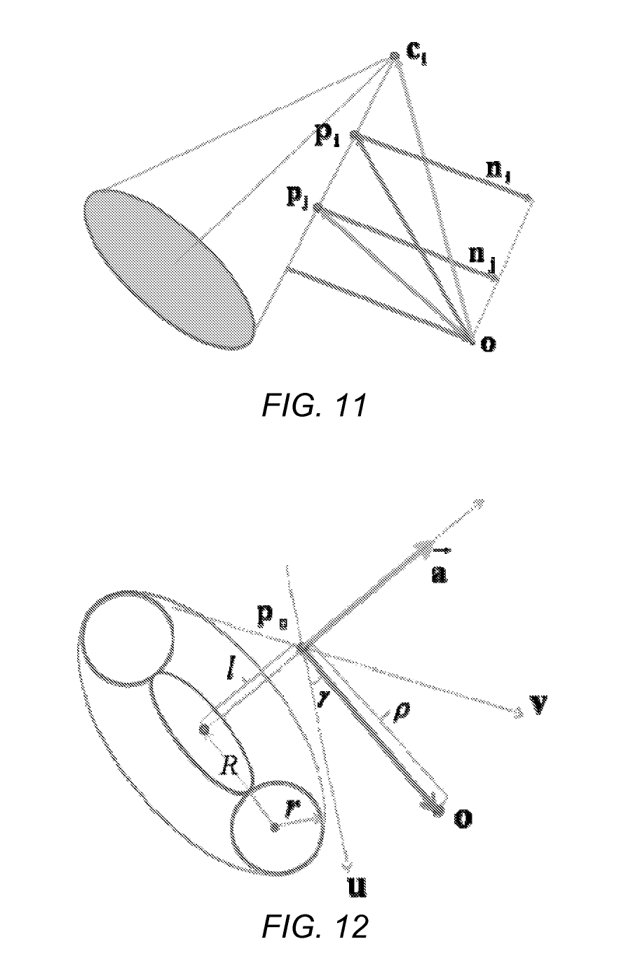

which can also be solved by the Levenberg-Marquardt method. FIG. 11 illustrates that for each point, the equation of \vec{p₁o}·\vec{n}ᵢ=\vec{co}·\vec{n}ᵢ holds in accordance with one or more embodiments of the invention.

After the position of the apex point is fixed, one can map the directions from each point to the apex to a Gaussian sphere. Obviously, the mapped points will form a circle on the Gaussian sphere. The plane of this circle will not pass through the origin of the Gaussian sphere. Plane fitting can be used to estimate the normal of the plane of the great circle. The result of the cone axis estimation may not be very good especially when outliers are present. However, this result may only be used as an initial value of the cone axis. The cone axis will be further optimized based on the faithful distance.

### Estimation of Position and Angle

After the hypothesis of the axis of the cone is obtained, all the points of the cone are rotated around the axis to a plane passing through the estimated cylinder direction by computing the orthogonal distance dᵢ from the point to the axis.

dᵢ=|a×(ρn−pᵢ)| (20)

If the estimated axis approximates the actual axis, the rotated points will form a straight line on the 2D plane. The position of the apex and the angle between the cone surface and the axis can be calculated by 2D line fitting. By computing the start point and end point of the line, a conical frustum can be obtained from the point cloud data.

### Overview of Cone Fitting

As described above, the initial estimate of four parameters are first obtained and then rotated around the cone axis to project the points onto the same plane (i.e., a line on the plane is formed). Line fitting may then be used to determine the equation of the line. Accordingly, a two step approach is used to optimize the parameters. In the first step, line fitting is used to determine initial values. In the second step, the distance from points to a real cone surface is minimized. Once minimized, the result provides a cone surface with fixed parameters based on the point cloud data.

Torus Fitting

FIG. 12 illustrates the parameterization of a torus in accordance with one or more embodiments of the invention. The torus can be obtained by revolving a circle around an axis coplanar with the circle. The radius of the circle is the minor radius of the torus and the distance from the center of the circle to the revolving axis is the major radius of the torus. In one or more embodiments of the invention, only tori where the major radius is larger than the minor radius is considered.

As in the parameterization of cone, four parameters (α, β, ρ, γ) are used to define the position and direction of the symmetry axis of the torus. r and R are the minor radius and the major radius respectively. l specifies the distance from the torus center and the projection point pₒ of the origin to the symmetric axis. Thus, a torus can be parameterized by seven parameters (α, β, ρ, γ, l, r, R).

The optimization problem of torus fitting can be formulated as [Jiao 2005]:

$$\begin{matrix}{v}_{opt} = {argmin}_{α , β , ρ , γ} [ {min}_{l , r , R} {\sum }_{i = 1}^{n} d ( {p}_{i} , f ( α , β , ρ , γ , l , r , R ) ) ] \\ = {argmin}_{α , β , ρ , γ} {A}_{3} ( α , β , ρ , γ )\end{matrix} \qquad ( 21 )$$

Here, the seven parameters are decomposed into two parts: (α, β, ρ, γ) and (l,r,R). After the value of symmetry axis (α, β, ρ, γ) is determined, all the points belonging to the torus surface can be transformed into a 2D space by rotating around the torus axis to a half plane which can be an arbitrary plane passing through the torus axis. If the estimated torus axis approximates the actual axis well, the points on the half plane will form a 2D arc or circle. Therefore, the estimation of the torus center and minor and major radius problem becomes a 2D circle fitting problem. Only (α, β, ρ, γ) needs to be considered for optimization. The task for each iteration is to find the best circle fitting to the rotated points on the half plane. Similarly, a two-step approach is utilized to get the initial parameters of a torus for Levenberg-Marquardt optimization. The symmetry axis of the torus is estimated in the first step and the position of the radius center and the minor and major radii of the torus are estimated in the second step.

### Initial Estimation of Axis Direction

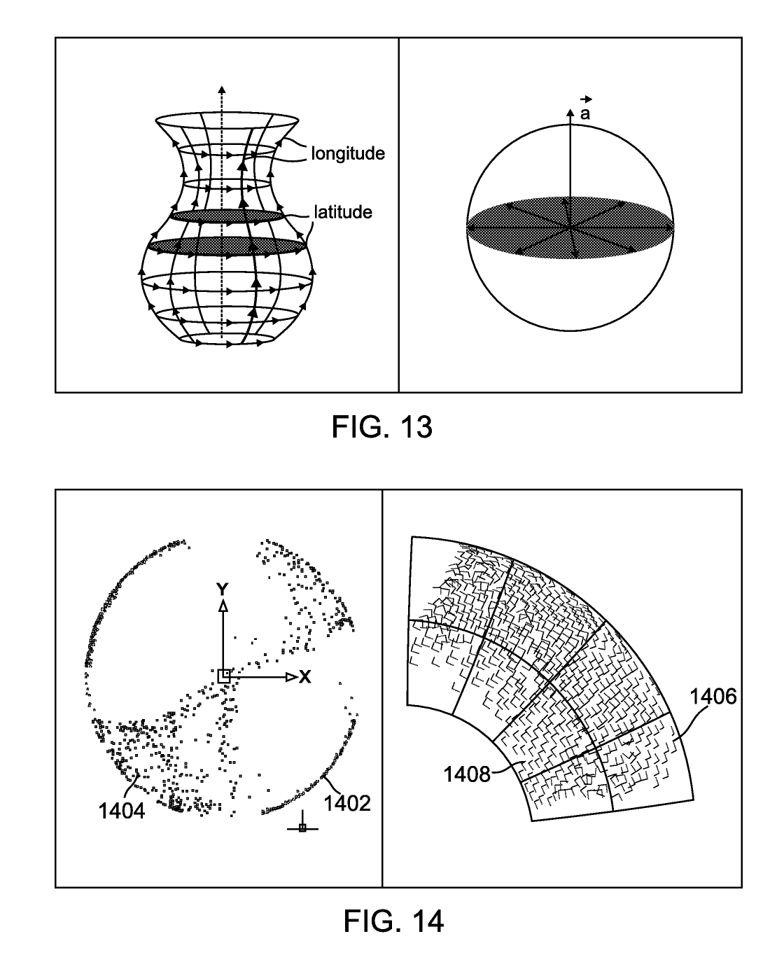

As a torus can be obtained by a revolving process, the problem of estimating the symmetric axis of a torus is generalized into the problem of estimating the rotating axis of a revolved surface. A revolved surface can be regarded as the composition of latitude curves and longitude curves. The latitude curves are orthogonal to the rotation axis and the longitude curves are coplanar with the rotation axis. Since longitude and latitude curves are curvature curves, one of the principal curvature directions must be the tangent vector of latitude curves. When the principal curvature direction vectors are mapped to a Gaussian sphere, the principal directions with regard to the latitude curves must be coplanar and the plane is perpendicular to the axis of rotation, i.e. the principal directions with regard to the latitude curves will ideally form a great circle on the Gaussian sphere. FIG. 13 illustrates the tangent vectors of latitude curves in accordance with one or more embodiments of the invention (i.e., the principal curvature directions with regard to longitude curves form a great circle on a Gaussian sphere) [Ke 2005]. The number of points on the great circle equals the number of points spreading on the great circle, which will make the feature of the great circle obvious on the sphere. Therefore, the problem of revolved axis estimation is converted into the extraction of the great circle on the Gaussian sphere.

By analyzing the curvature property of points on a torus whose major radius is greater than its minor radius, one can find out that for most of the time, the minimum principal curvature directions will form a great circle on the Gaussian sphere, while the maximum principal curvature directions will distribute sparsely on the Gaussian sphere. FIG. 14 illustrates differential properties of the points on a torus surface that can be used for resolved axis determination. On the left side of FIG. 14, points 1402 are the Gaussian mapping of the vectors of minimum principal directions while points 1404 are the Gaussian mapping of the vectors of maximum principle directions. The right side of FIG. 14 illustrates the principal directions of the points on a torus surface. The line segments 1406 are the minimum principal directions and line segments 1408 are the maximum principal direction.

To extract the axis direction of a torus, one takes the priority to map the minimum principal curvature directions to the Gaussian sphere first. Then, the same Hough mapping approach in the cylinder direction estimation is used to extract the normal of the great circle. Plane fitting can be used to estimate the normal of the plane of the great circle only when the data contain little outliers and the number of points used for fitting is big enough to ignore the effect of outliers. If the initial estimation using only minimum principal directions fails to fit a good torus shape from the point cloud data, both minimum and maximum principal directions are mapped to the Gaussian sphere and the great circle is extracted by point clustering approach [Fung 2001].

### Principal Curvature Estimation

To obtain robust curvature information of a point p on the underlying surface, a polynomial surface instead a planar surface is fit to the points around p [Bauer 2007]. A tangent plane estimated using KNN may be used as a reference domain to compute the polynomial approximation.

With weighting function θᵢ=θ(∥p−pᵢ∥), the fitting of paraboloid f(x,y)=ax²+by²+cxy+dx+ey+f is to minimize:

Σᵢ(f(xᵢ,yᵢ)−zᵢ)²θᵢ (22)

The minimization problem can be converted to solve a linear equation system:

$$\begin{matrix}{A}^{T} ( \begin{matrix}{θ}_{1} & & 0 \\ & ⋱ & \\ 0 & & {θ}_{n}\end{matrix} ) A ( \begin{matrix}a \\ b \\ ⋮ \\ f\end{matrix} ) = {A}^{T} ( \begin{matrix}{θ}_{1} {z}_{1} \\ {θ}_{2} {z}_{2} \\ ⋮ \\ {θ}_{n} {z}_{n}\end{matrix} ) \\ where & ( 23 ) \\ A = ( \begin{matrix}{x}_{1}^{2} & {y}_{1 }^{2} & {x}_{1} {y}_{1} & {x}_{1} & {y}_{1} & 1 \\ & & ⋮ & & & \\ {x}_{n}^{2} & {y}_{n}^{2} & {x}_{n} {y}_{n} & {x}_{n} & {y}_{n} & 1\end{matrix} ) . & ( 24 )\end{matrix}$$

The matrix representation of the first and second fundamental forms at (0,0) is:

$$G = ( \begin{matrix}{d}^{2} + 1 & de \\ de & {e}^{2} + 1\end{matrix} ) and H = \frac{1}{\sqrt{1 + {d}^{2} + {e}^{2}}} ( \begin{matrix}2 a & c \\ c & 2 b\end{matrix} ) \qquad ( 25 )$$

The eigenvectors of the matrix represent the principal curvature directions in the basis of

$$\frac{\partial }{\partial x} , \frac{\partial }{\partial y} .$$

The eigen-values are the corresponding principal curvatures κₘᵢₙ and κₘₐₓ.

### Estimation of Minor and Major Radius

Once an initial value of the symmetric axis of the torus is obtained, firstly, pᵢ is transformed into a local coordinate system formed by (u,v,a):

p′ᵢ=M^{T}(pᵢ−ρn),where M=[u,v,a]. (26)

Thereafter, p′ᵢ is further rotated around a-axis into ua-plane:

$${p}_{i}^{″} = [ \begin{matrix}cos θ & sin θ & 0 \\ 0 & 0 & 1\end{matrix} ] {p}^{′} , \qquad ( 27 )$$

where θ is the angle between a-axis and the projection of \vec{pₒp₁′} onto uv-plane.

The same Taubin circle fitting algorithm may be used as that in cylinder fitting to determine the center and radius of the circle. Thereafter, the radius of the circle is the minor radius of the torus, and the distance from the circle center to the torus axis is the major radius of the torus. The torus center can be computed by transforming the project of the circle center onto the torus axis into 3D space.

### Logical Flow

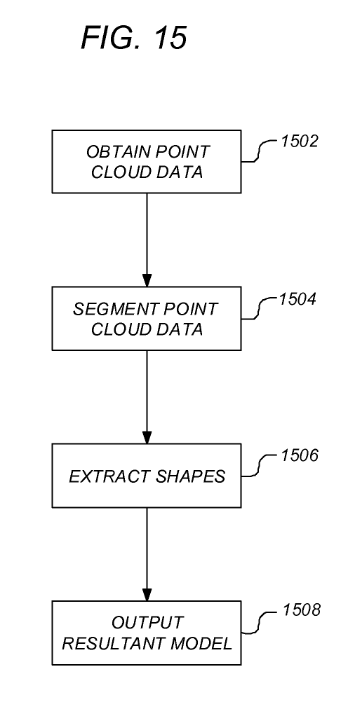

FIG. 15 illustrates the logical flow for extracting a primitive quadric surface from point cloud data. At step 1502, point cloud data is obtained in the 3D space.

At step 1504, the point cloud data is segmented to create a disjoined surface and a smooth surface segment based on spatial connectivity and surface smoothness. Such segmenting may include the process delineated in FIG. 4.

At step 1506, one or more shapes are extracted from the point cloud data using geometric fitting. The geometric fitting includes searching for one or more quadric surface parameters of a given type of model that provides a best agreement between one or more selected points from the point cloud data and a resultant model. Linear least square fitting may be used to perform the geometric fitting for planes and spheres while non-linear least square fitting can be used to perform the fitting for cylinders, cones, and tori. The geometric fitting decomposes the one or more quadric surface parameters into two parts to reduce a dimension of parameter spaces. In this regard, the two parts may include a first part that is solved by iterative optimization and a second part that is directly solved.

Accordingly, a similar two-step approach may be utilized for the different models/shapes that are extracted. Differences between the different models/shapes include the parameters that are used to define the respective shape. The quadric surface parameters for a cylinder comprises five parameters \vec{v}=(α, β, ρ, γ, r), where ρ is an orthogonal distance from an origin to an axis of the cylinder, γ is an angle between u and a unit normal vector (n=u sin γ+v cos γ) from the origin to the axis and r is a radius of the cylinder. The five parameters are initially obtained by estimating a cylinder direction in a first step, and estimating the radius and position of the cylinder in a second step.

Six parameters (α, β, ρ, γ, l, ω) may be used to describe a cone. a=a(α,β) represents a unit vector of a cone axis, ρ is an orthogonal distance from an origin to the cone axis, γ is an angle between u and a unit normal vector (n=u sin γ+v cos γ) from the origin to the cone axis, pₒ is a projected point of the origin on the cone axis, distance l is a position of the cone apex from an apex point c to pₒ, and ω, 0<ω<π/2 is an angle between the cone axis and a cone surface. The six parameters are initially obtained by estimating the cone axis in a first step, and estimating the position of the cone apex and the angle between the cone axis and the cone surface in a second step.

The quadric surface parameters for a torus includes seven parameters (α, β, ρ, γ, l, r, R), wherein (α, β, ρ, γ) are used to define a position and direction of a symmetry axis of the torus, r and R are a minor radius and a major radius respectively, and l specifies a distance from a torus center and a projection point pₒ of an origin to the symmetric axis.

At step 1508, the resultant model that includes the extracted shapes is output (e.g., displayed on a display device, communicated to a user, stored in persistent memory, etc.).

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

In summary, some fundamentals of shape extraction from point cloud problem have been described. Normal and connectivity information are essential to various point cloud processing applications. The normal estimation can be achieved both by uniform and weighted plane fitting. Connectivity information is obtained by constructing a K-d tree to organize the point cloud data so that KNN query can be reported efficiently. Segmentation could be used to group points belonging to a smooth surface together, which is very useful for point cloud analysis and labeling.

Primitive quadric surface fitting is the main principle of as-built CAD modeling. While planes and spheres can be easily fitted by linear least square fitting approach, the fitting of cylinder, cones and tori is non-linear. Non-linear least square fitting problem may be solved using the Levenberg-Marquardt method. To provide a good initial estimation for the optimization, different approaches are proposed based on the property of each shape to achieve a good initialization. The optimization process is simplified by a parameter decomposition technique that reduces the parameters to be minimized, thereby decreasing the risk of falling into a local minimum and making the shape fitting algorithms more robust and efficient. The effect of noise in the measured point cloud data is averaged by fitting models. Fitting based on least squares also provides quantized measurement on the quality of the extracted quadric surfaces, which will be valuable for decision making.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

### REFERENCES

ANDREW WILLIS, XAVIER ORRIOLS, DAVID B. COOPER, 2003, Accurately Estimating Sherd 3D Surface Geometry with Application to Pot Reconstruction, cvprw, vol. 1, pp. 5, 2003 Conference on Computer Vision and Pattern Recognition Workshop—Volume 1, 2003.
ARYA S., MOUNT D. M, 2010, ANN: A Library for Approximate Nearest Neighbor Searching, HTTP://WWW.CS.UMD.EDU/˜MOUNT/ANN/.
ARYA S., MOUNT D. M., NETANYAHU N. S., SILVERMAN R., 1998, An optimal algorithm for approximate nearest neighbor searching in fixed dimensions;. Journal of ACM, Volume 45(6), 891-923.
BAUER, U. AND POLTHIER, K. 2007. Parametric Reconstruction of Bent Tube Surfaces. In Proceedings of the 2007 international Conference on Cyberworlds (Oct. 24-26, 2007). International Conference on Cyberworlds. IEEE Computer Society, Washington, D.C., 465-474.
BOSCHE F., 2003, Model Spell Checker’ for Primitive-based As-built Modeling in Construction, Master of Science Thesis, Supervisor: Dr. Katherine A. Liapi and Dr Carl T. Haas, Department of Civil, Architectural and Environmental Engineering, University of Texas at Austin (USA).
ERMES, P., HEUVEL, F. A. V. D. AND VOSSELMAN, G., 1999. A photogrammetric measurement method using CSG models. In: IAPRS, Vol. 32, part 5/W11, pp. 36-42.
FUNG, G., A Comprehensive Overview of Basic Clustering Algorithms, May. 2001.
HOUGH, P. V. C., 1962, Methods, means for recognizing complex patterns, U.S. Pat. No. 3,069,654.
JIANG, X. Y., CHENG, D. C., 2005, A Novel Parameter Decomposition Approach to Faithful Fitting of Quadric Surfaces, In: Pattern Recognition: 27th DAGM Symposium, Lecture Notes in Computer Science, vol. 3663, pp. 168-175.
KAZHDAN, M., BOLITHO, M., AND HOPPE, H., 2006, Poisson Surface Reconstruction, Symposium on Geometry Processing (June 2006), 61-70.
KE Y. L, LI. A, 2005, Rotational surface extraction based on principal direction Gaussian image from point cloud, Journal Of Zhejiang University (Engineering Science), 2006 40(6). (In Chinese)
LUTTON, E., MAITRE, H. and LOPEZ-KRAHE, J., 1994, Contribution to the determination of vanishing points using Hough transform. IEEE Trans. Pattern. Anal. Mach. Intell. 16(4), 430-438.
LUKÂCS, G., MARSHALL, A. D. and MARTIN, R. R., 1998, Faithful Least-Squares Fitting of Spheres, Cylinders, Cones, and Tori for Reliable Segmentation, Proc. Fifth European Conf. Computer Vision (ECCV '98), vol. I, 671-686.
MARSHALL, D., LUKACS, G. AND MARTIN, R. 2001, Robust segmentation of primitives from range data in the presence of geometric degeneracy, IEEE Transaction on Pattern Analysis and Machine Intelligence, 23(3), 304-314.
MATTEW, D. B, RONALD, S. F, 1993. Determining the axis of a surface of revolution using tactile sensing, IEEE transaction on Pattern Analysis and Machine Intelligence, 1993, 15(10), 1079-1087.
MITRA N. J., NGUYEN A., Guibas L. 2004,: Estimating surface normals in noisy point cloud data. In International Journal of Computational Geometry & Applications, 4(4-5). pp. 261-276.
NOURSE, B. E., IIAKALA, D. G., HILLYARD, R. C., and MALRAISON, P. J., 1980. Natural quadrics in mechanical design. In: Proceedings of Autofact West 1, Anaheim, Calif., 363-378.
PAULY M., KEISER R., KOBBELT L., GROSS M. 2003: Shape modeling with point-sampled geometry. In Proceedings of ACM SIGGRAPH 2003 (2003), ACM Press, pp. 641-650.
PETITJEAN, S., 2002. A survey of methods for recovering quadrics in triangle meshes. ACM Computing Surveys, 34(2), pp. 211-262.
PRATT, V. Direct lease-squares fitting of algebraic surfaces. Computer Graphics, 21(4): 145-152, July 1987.
RUSIN, D., 2004, Topics on Sphere Distribution. http://www.math.niu.edu/˜rusin/known-math/95/sphere.faq.
RUWEN S., ROLAND W., REIHARD K., Shape Detection in Point Clouds, Computer Graphics Forum (2007), Volume: 26, Issue: 2, Pages: 214-226.
SÖREN, K., 2009, Consistent Propagation of Normal Orientation in Point Clouds, In Proceedings of VMV 2009.
TAHIR, R. s., 2005, Automatic Reconstruction of Industrial Installations Using Point Clouds and Images, Ph.D Dissertations of TU Delft, ISBN-10: 90 6132 297 9.
TAUBIN, G., 1991, Estimation Of Planar Curves, Surfaces And Non-planar Space Curves Defined By Implicit Equations, With Applications To Edge And Range Image Segmentation”, IEEE Trans. PAMI, Vol. 13, 1115-1138.
TRUCCO, E. and FISHER, R. B., 1995. Experiments in curvature-based segmentation of range data. PAMI 17(2), pp. 177-182.
ANDREW WILLISY, XAVIER ORRIOLSZ, DAVID B. COOPER, 2003, Accurately Estimating Sherd 3D Surface Geometry with Application to Pot Reconstruction, Computer Vision and Pattern Recognition workshop.

What is claimed is:

1. A computer implemented method for extracting a primitive quadric surface from point cloud data, comprising:
(a) obtaining point cloud data in three-dimensional (3D) space;
(b) segmenting the point cloud data to create a disjoined surface and a smooth surface segment based on spatial connectivity and surface smoothness;
(c) extracting one or more shapes from the point cloud data using geometric fitting; wherein the geometric fitting comprises searching for one or more quadric surface parameters of a given type of model that provides a best agreement between one or more selected points from the point cloud data and a resultant model; and
(d) outputting the resultant model that includes the extracted shapes.

2. The computer implemented method of claim 1, wherein the segmenting comprises:
(a) selecting a point in the point cloud data with a minimum residual as a current seed;
(b) if all of the points in the point cloud data have been segmented, return a segmentation result;
(c) obtain neighboring points of the current seed using k-nearest neighbor processing to create a current region;
(d) adding one or more points from the point cloud that satisfy a condition to the current region;
(d) adding one or more points from the point cloud with residuals less than a threshold value to a potential seed points queue;
(e) if the potential seed points queue is not empty, select a top seed in the queue as the next seed and return to step (c); and
(f) adding the current region to the segmentation result and returning to step (a).

3. The computer implemented method of claim 1, wherein linear least square fitting is used to perform the geometric fitting for planes and spheres.

4. The computer implemented method of claim 1, wherein non-linear least square fitting is used to perform the geometric fitting for cylinders, cones, and tori.

5. The computer implemented method of claim 1, wherein:
the geometric fitting decomposes the one or more quadric surface parameters into two parts to reduce a dimension of parameter spaces;
the two parts comprise a first part that is solved by iterative optimization and a second part that is directly solved.

6. The computer implemented method of claim 5, wherein the quadric surface parameters for a cylinder comprises five parameters \vec{v}=(α, β, ρ, γ, r), where ρ is an orthogonal distance from an origin to an axis of the cylinder, γ is an angle between u and a unit normal vector (n=u sin γ+v cos γ) from the origin to the axis and r is a radius of the cylinder.

7. The computer implemented method of claim 6, wherein the five parameters are initially obtained by:
estimating a cylinder direction in a first step; and
estimating the radius and position of the cylinder in a second step.

8. The computer implemented method of claim 5, wherein the quadric surface parameters for a cone comprises six parameters (α, β, ρ, γ, l, ω), where a=a(α,β) represents a unit vector of a cone axis, ρ is an orthogonal distance from an origin to the cone axis, γ is an angle between u and a unit normal vector (n=u sin γ+v cos γ) from the origin to the cone axis, pₒ is a projected point of the origin on the cone axis, distance l is a position of the cone apex from an apex point c to pₒ, and ω, 0<ω<π/2 is an angle between the cone axis and a cone surface.

9. The computer implemented method of claim 8, wherein the six parameters are initially obtained by:
estimating the cone axis in a first step; and
estimating the position of the cone apex and the angle between the cone axis and the cone surface in a second step.

10. The computer implemented method of claim 5, wherein the quadric surface parameters for a torus comprises seven parameters (α, β, ρ, γ, l, r, R), wherein (α, β, ρ, γ) are used to define a position and direction of a symmetry axis of the torus, r and R are a minor radius and a major radius respectively, and l specifies a distance from a torus center and a projection point pₒ of an origin to the symmetric axis.

11. The computer implemented method of claim 10, wherein the seven parameters are initially obtained by:
estimating the symmetry axis in a first step; and
estimating a radius center position, major radius, and minor radius in a second step.

12. A computer modeling system for extracting a primitive quadric surface from point cloud data, in a computer system comprising:
(a) a computer having a memory; and
(b) an application executing on the computer, wherein the application is configured to:
(i) obtain point cloud data in three-dimensional (3D) space;
(ii) segment the point cloud data to create a disjoined surface and a smooth surface segment based on spatial connectivity and surface smoothness;
(iii) extract one or more shapes from the point cloud data using geometric fitting; wherein the geometric fitting comprises searching for one or more quadric surface parameters of a given type of model that provides a best agreement between one or more selected points from the point cloud data and a resultant model; and
(iv) output the resultant model that includes the extracted shapes.

13. The computer modeling system of claim 12, wherein the application is configured to segment by:
(a) selecting a point in the point cloud data with a minimum residual as a current seed;
(b) if all of the points in the point cloud data have been segmented, return a segmentation result;
(c) obtain neighboring points of the current seed using k-nearest neighbor processing to create a current region;
(d) adding one or more points from the point cloud that satisfy a condition to the current region;
(d) adding one or more points from the point cloud with residuals less than a threshold value to a potential seed points queue;
(e) if the potential seed points queue is not empty, select a top seed in the queue as the next seed and return to step (c); and
(f) adding the current region to the segmentation result and returning to step (a).

14. The computer modeling system of claim 12, wherein linear least square fitting is used to perform the geometric fitting for planes and spheres.

15. The computer modeling system of claim 12, wherein non-linear least square fitting is used to perform the geometric fitting for cylinders, cones, and tori.

16. The computer modeling system of claim 12, wherein:
the geometric fitting decomposes the one or more quadric surface parameters into two parts to reduce a dimension of parameter spaces;
the two parts comprise a first part that is solved by iterative optimization and a second part that is directly solved.

17. The computer modeling system of claim 16, wherein the quadric surface parameters for a cylinder comprises five parameters \vec{v}=(α, β, ρ, γ, r), where ρ is an orthogonal distance from an origin to an axis of the cylinder, γ is an angle between u and a unit normal vector (n=u sin γ+v cos γ) from the origin to the axis and r is a radius of the cylinder.

18. The computer modeling system of claim 17, wherein the five parameters are initially obtained by:
estimating a cylinder direction in a first step; and
estimating the radius and position of the cylinder in a second step.

19. The computer modeling system of claim 16, wherein the quadric surface parameters for a cone comprises six parameters (α, β, ρ, γ, l, ω), where a=a(α,β) represents a unit vector of a cone axis, ρ is an orthogonal distance from an origin to the cone axis, γ is an angle between u and a unit normal vector (n=u sin γ+v cos γ) from the origin to the cone axis, pₒ is a projected point of the origin on the cone axis, distance l is a position of the cone apex from an apex point c to pₒ, and ω, 0<ω<π/2 is an angle between the cone axis and a cone surface.

20. The computer modeling system of claim 19, wherein the six parameters are initially obtained by:
estimating the cone axis in a first step; and
estimating the position of the cone apex and the angle between the cone axis and the cone surface in a second step.

21. The computer modeling system of claim 16, wherein the quadric surface parameters for a torus comprises seven parameters (α, β, ρ, γ, l, r, R), wherein (α, β, ρ, γ) are used to define a position and direction of a symmetry axis of the torus, r and R are a minor radius and a major radius respectively, and l specifies a distance from a torus center and a projection point pₒ of an origin to the symmetric axis.

22. The computer modeling system of claim 21, wherein the seven parameters are initially obtained by:
estimating the symmetry axis in a first step; and
estimating a radius center position, major radius, and minor radius in a second step.
